(19) United States
(12) Patent Application Publication
(10) Pub. No.: US 2004/0098673 A1
(43) Pub. Date: May 20, 2004

(54) System and method for managing reference values

(76) Inventors: Damian Mark Riddoch, Riverton, UT (US); Val A. Johnson, Riverton, UT (US); Brett Andrew Hansen, Draper, UT (US)

Correspondence Address: DAMIAN RIDDOCH, 4881 WEST CAVE PEAK DRIVE, RIVERTON, UT, 84065, US

(21) Appl. No.: 10/713,136

(22) Filed: Nov. 14, 2003

Related U.S. Application Data
(60) Provisional application No. 60/426,322, filed on Nov. 14, 2002.

(51) Int. Cl. G06F 17/00

(52) U.S. Cl. 715/537

(57) ABSTRACT

The system disclosed herein is an interface that allows the drafter of a technical document, such as a patent application, to keep both element names and reference numerals consistent throughout a text document and any accompanying documents, including drawings. The system creates and manages a global table of terms that may be edited globally and applied to both a text document and a drawing file. The system also provide for the examination and correction of a technical document that used element names and reference numerals to ensure consistency.

This United States patent application claims priority to U.S. Provision Patent Application No. 60/426,322 filed on Nov. 14, 2002 and entitled System and Method for Managing Reference Values.

### BACKGROUND

1. Field of the Invention

The present invention relates to the management of reference values in a text document and drawing file. More specifically, the present invention relates to a computer program for managing reference numerals in a technical writing document and associated drawings, such as a United Stated patent application.

2. Background of the Relevant Technology

Technical documents such as patent applications, instruction manuals, process manuals, and computer manuals utilize detailed descriptions to define an object, a design, a process, a method, or a strategy. To clarify the description, a series of drawings are typically provided where items in the drawings are references to a text documents though the use of element names and associated reference numerals. These element names and related reference numerals are often used repeatedly throughout the document which may or may not be lengthy. Often, through error, the use of an element name and/or reference numeral is not consistent within a document or between the documents and the drawings. Thus, the need exists for a method of managing and checking those element names and reference numerals for the purpose of increasing the efficiency and accuracy in the creation of these documents and drawings.

In addition, the drawings or other accompanying documents are often created by someone other than the individual or group who is writing the text description. For this reason a need exists to provide a method of communication between the one(s) writing the text and the one(s) creating the other documents or drawings to clarify the functionality and/or the changes made to the other documents or drawings, assuring their consistency with the related document.

### SUMMARY

The present application relates to a system for managing reference numerals. The system includes an element database for receiving and storing a plurality of element names and reference database for receiving and storing a plurality reference numerals. Within the system, selective reference numerals in the reference database correspond to selective element names in the element database. The system also includes a manager system in communication with the element database, the reference database, and at least one document file. The manager system provides for a user designated insertion of element names and reference numerals into the document file, such that changes to an element name in the element database or changes to a reference numeral in the reference database, correspondingly change the element name or reference numeral in the document file.

The manager system may be a window or pull down menu accessible through a word processing program. The system may include multiple features such as automatic reference numeral function, hotkey insertion of element names and reference numerals into a document file, and control over insertion of capital or plural forms of the element names in the document. The system also provides for the insertion of element names and reference numerals into a drawing file, wherein the element names and reference numerals may be updated within the drawing file according to changes within element database and the reference database.

Another aspect of the present application is the presence of a correcting function for verifying the consistent used of element names and reference numerals in a document. The correcting function employs the steps of identifying a reference numeral within a text document; providing for selection of an element name associated with the reference numeral from the text document; storing the element name and the associated reference numeral in an element name and reference numeral database, such that the reference numeral and element name are associated with each other; identifying subsequent occurrences of the reference numeral, wherein the subsequent occurrence of the reference numeral and the associated element name are compared with the element name and reference numeral database; indicating the presence of an inconsistency between the reference numeral and element name in the database and the subsequent occurrence of the reference numeral and the element names in the text document; and repeating the steps for other reference numerals and element names until an determined number of reference numerals are identified.

### BRIEF DESCRIPTION OF THE DRAWINGS

In order that the manner in which the features and advantages of the invention and its multiple embodiments be readily understood, a more particular description of the invention briefly described above will be rendered by reference to specific embodiments thereof which are illustrated in the appended figures. Understanding that these figures depict only typical embodiments of the invention and are not therefore to be considered to be limiting of its scope, the embodiments will be described and explained with additional specificity and detail through the use of the accompanying figures in which:

FIG. 1 is a flow diagram of a reference numeral management system.

FIG. 2 is a flow diagram of a correcting function system.

### DETAILED DESCRIPTION

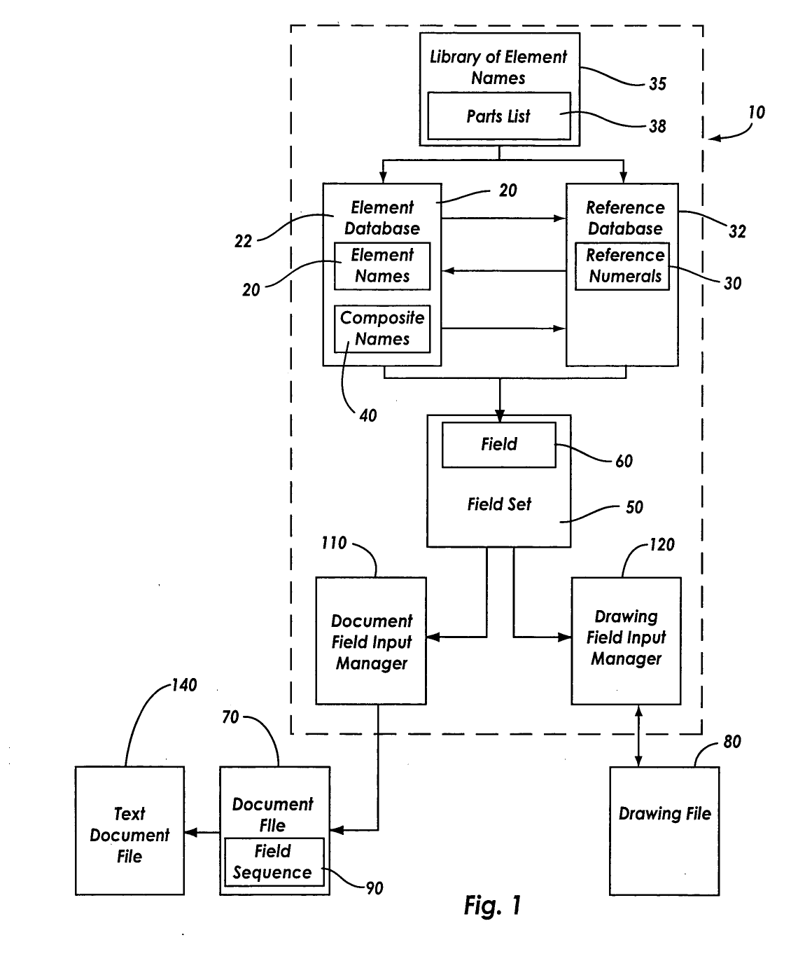

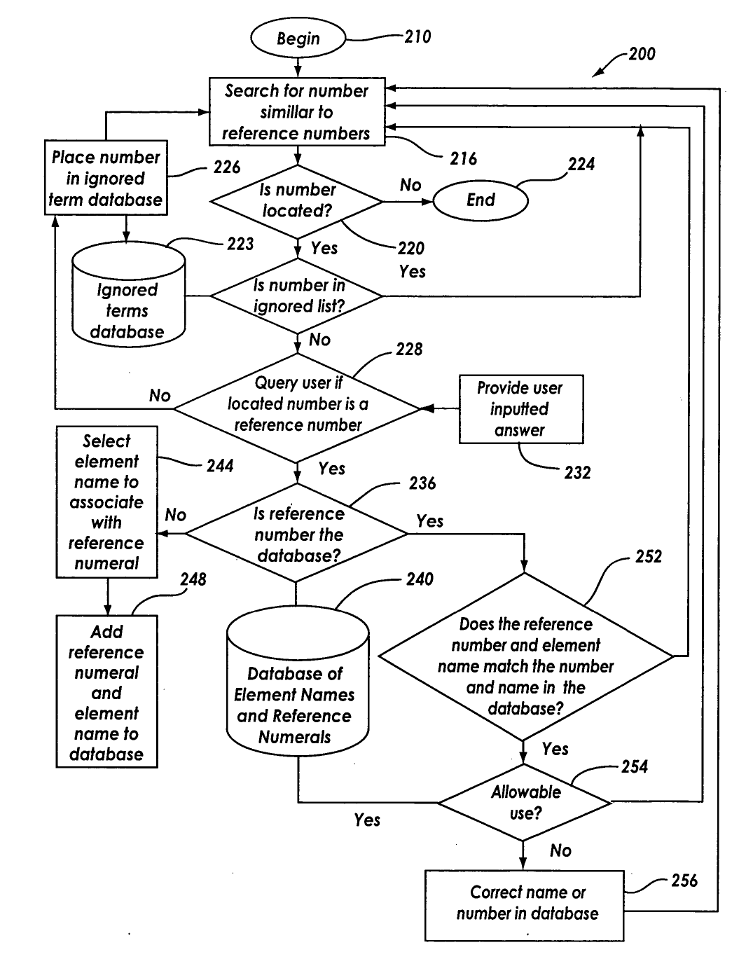

The embodiments of the present invention will be best understood by reference to the figures, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1-2 is not intended to limit the scope of the invention, as claimed, but is merely representative of presently preferred embodiments of the invention.

Referring now to FIG. 1, a management system 10 is illustrated that may be employed in managing element names 20 and reference numerals 30 in documents, instruction manuals, or the like where various written textual information is supported by referencing the reader to drawings or other visual mediums through the use of reference numbers 30. Generally, an element name 20 provides a type of written description of a particular object where the described object is likewise shown in an accompanying drawings, figure, or picture. A reference numeral 30 provides a simplified notation for the element name 20, whereby the element is identified in the associated drawings by the reference numeral 30.

One example of the use of element names 20 and reference numerals 30 in a document is a patent application. As illustrated herein and in numerous other patents, a patent application generally comprises of a written description of the invention, where the written description references various associated figures. The written description will often refer to various components of the invention, or elements names 20. The element names 20 are associated with reference numerals 30 to allow easy referencing between the written description and the figures. Because a patent application is an exemplar embodiment of a document having both element names 20 and reference numerals 30, reference to a patent application will serve as a model in the description of the present system.

It is, however, important to note that the present invention applies to any application where drawings, figures, or other supplemental information are being referred to in a document. Other examples may include operating and assembly instruction, legal documents referencing exhibits, or other technical documents. Therefore, reference herein to a patent application is only by way of example, and is not intended to be limiting.

The reference numeral management system 10, shown in FIG. 1, includes a list of element names 20 and a list of reference numerals 30 located in an element database 22 and a reference database 32 respectively. The list of element names 20 may be a list of parts or members shown in a figure or drawing. The element names 20 may be any combination of related or unrelated terms, such as parts of a machine or body, exhibits or appendices, etc.

The list of element names 20 has a corresponding list of reference numerals 30 which allows a reader of the written description or text portion of the document to easily reference the element name 20 to the corresponding portions of the figures or drawings. The reference numerals 30 are generally a list of numbers, alphanumeric characters or symbols, etc. that allow the reader to refer a discussion in a document to a specific item or location of the drawing. Therefore, the list of element names 20 corresponds to reference numerals 30, where one or more reference numeral 30 is assigned to one or more element names 20.

The list of element names 20 and the list of reference numerals may be stored in, or part of, an element database 22 and a reference database 32, respectfully. The databases 22 and 32 are computer readable mediums, well known to those of ordinary skill in the art, that allow lists of element names 20 and lists of reference numerals 30 to be stored, edited, and removed depending upon the project that is currently being edited.

The management system 10 provides a continuing association between the element names 20 in the element database 22 and the list of reference numerals 30 in the reference database 32. This association allows individual element names 20 to be edited or otherwise changed in the element database 22, while maintaining the relationship with their associated reference numerals 30 in the reference database 32. This association functions such that if an item is given a new element name 20, the change of name does not effect the association between the element name 20 and the corresponding reference numeral 30. For example, if the element name 20 is “FOOT BONE” and the reference numeral 30 is “17,” the change of the element name 20 from “FOOT BONE” to “ANKLE BONE” will result in the combination of “ANKLE BONE 17.” This item could be inserted into the document in various forms, including but not limited to the element name 30 only, the reference number 20 only, or the element name 30 and reference number 20 combined in a field set 50. Likewise, the reference numerals 30 may be changed while remaining associated with the corresponding element names 20. Such a correspondence between the element names 20 and the reference numerals 30 allows both the element names 20 and the reference numerals 30 to be easily and consistently changed while revising the document.

This relationship between element names 20 and reference numerals 30 may be maintained by assigning the element names 20 and the reference numerals 30 a location on a table such that the individual cells are identified by column and row. The management system 10, or other associate program, will create an association between specific element names 20 and reference numerals 30 based upon the column and row locations. When an element name 20 is changed to a new element name 20, the new element name 20 is placed in the same cell as the previous element names 20. Because the change in element name 20 has not effected the cell location, the reference numeral 30 will maintain its relationship with the new element name 20 based upon the column and row location of the cell. This manner of maintaining the relationship between the element names 20 and the reference numerals 30 also occurs when the reference numeral is changed.

The use of a table may also be employed when creating the list of elements names 20 and reference numerals 30. In one embodiment, the user or draftsman may open a table having a column designated for the input of element names 20 and the column for the input of associated reference numerals 30. The user would then input the desired element name 20 and reference numerals 30 on adjacent rows, where the management system recognizes that adjacent rows are associated. Such a table allows for a simple and intuitive input system.

Moreover, various functionalities may be added to such a table. For example, the user may input a starting value and an increment between the different reference numerals 30. When the user inputs the first element name 20, the management system will automatically assign the reference numeral 30 as the starting value. When the second element name 20 is added to the table, the management system will add the increment to the starting value which is automatically assigned to the second element name 20 and so on. Such an automatic system allows for rapid entry and is easily programmable with typical database programming functions.

In another embodiment, each element name 20 and reference numeral 30 may be assigned a tag upon creation, where the tag is a hidden identification element. Each tag function to follow the element name 20 or reference numeral 30 through any changes or revision. If an element name 20 or reference numeral 30 is revised, the new name or numeral is assigned the previous name or numeral's tag. Thus, a correlation between element names 20 and reference numerals 30 may be maintained through multiple revisions. In yet another embodiment, a history may be maintained by the manager system 10 to track changes and revision of the individual element names 20 and reference numerals 30. The history file allows the correlation between the element names 20 and reference numerals 30 to be maintained despite multiple revisions.

In some embodiments, the management system 10 may include a library of element names 35. The library of element names 35 can contain various parts lists 38 for a large variety of topics, where a single parts list 38 is comprised of multiple element names 20 associated with multiple reference numerals 30. For example, in a patent application, the patent draftsman may draft multiple patents in a similar field, such as electronic modules or medical devices. Rather than drafting a new list of element names 20 and associated list of reference numerals 30 for each individual project, a parts list 38 may be imported into both the element database 22 and the reference database 32 from the library. The parts list 38 may be a list from a prior project or a number of standardized parts lists 38. These parts lists 38 may further be edited to customize the element names 20 and the reference numerals 30 to match the needs of the current project. The library of element names 35 can store multiple parts lists 38 for a vast number of technological or similar fields.

Both the list of element names 20 and the corresponding list of reference numerals 30 may be part of and stored on a computer readable medium, such as a disk or disk drive, as could the parts list 35. Furthermore, the list of element names 20 and the list of reference numerals 30 may be part of a computer program, such as a word processor or spreadsheet program, or may be associated with a separate computer program. In one embodiment, the list of element names 20 and the list of reference numerals 30 are part of an “add-in function” within a Microsoft Word® file or other similar programs including word processors such as the WordPerfect® word processor. In another embodiment, the present system, method, and program could function as a stand alone program with its own built in word processor and database functionality.

Referring back to the diagram of FIG. 1, after a user has selected or imported a list of the element names 20 and reference numerals 30, whether hand selected or automatically selected, the element names 20 and the reference numeral 30 may be merged into a field set 50, or similar database capable of managing a large number of fields. The field set 50 is comprised of at least one or more fields 60 that include at least one element name 20 and at least one reference numeral 30. A field 60 allows an element name 20 and a reference numeral 30 to be treated as a single element or item in a word processing program or other program, such that the element name 20 and the reference numeral 30 are inseparable within a document. Thus, a field 60 allows an element name 20 and a reference numeral 30 to be contained within a single object, allowing for faster and simpler insertion into and management of the documents. This also ensures that the element names 20 and the corresponding reference numerals 30 remain associated to each other and consistent throughout the document or other file. The use of fields 60 also reduces the number of objects that are inserted in a document.

The field set 50 is in communication with the list of element names 20 and the list of reference numerals 30, such that as the element names 20 or reference numerals are updated or modified, the fields 60 within the field set 50 are likewise updated. The element names 20 and the reference numeral 30 in the field set 50 may automatically update as the list of element names 20 and the list of reference numerals 30 are changed in the element database 22 and reference database 32 respectively. Alternatively, the fields 60 in the field set 50 may be updated at a user defined time or at some other preset time.

In another embodiment, the use of a field set 50 and field 60 may be omitted. In such an embodiment, the management system would control the individual element names 20 and reference numeral 30 separately, where the element names 20 would be a separate field or other objects in a document from the reference numerals 30. The management system 10 would simply place the individual element names 20 and reference numerals 30 adjacent one another in a document. Also, an individual element name 20 may be comprised of multiple words, such as an element named “ANKLE BONE” where the terms “ANKLE” and “BONE” are merged in a single field, i.e. the words are inseparable within a document. In yet another embodiment, the element names 20 may be inserted as individual words or terms, employing no fields 60.

In an system employing field sets 50, once the list of element names 20 and the list of reference numerals 30 are stored in the field set 50, the element names 20 and the reference numerals 30 may be inserted as a field 60, or in other formats, into a document file 70 or a drawing file 80 through a document field input manager 110 and a drawing field input manager 120.

A document field input manager 110 and a drawing field input manager 120 are employed to manage the insertion of element names 20 and reference numerals 30 into the document file 70 and the drawing file 80 respectively. The document field input manager 110 and the drawing field input manager 120 act as an interfaces to transfer the element names 20 and the reference numerals 30 from the element database 22 and reference database 32 respectively (or from the field set 50), into the document files 70 and the drawing files 80. The interface ability of the input managers 110, 120 allows the element names 20 and the reference numerals 30 to be selectively inserted into document files 70 and drawing file 80.

The document field input manager 110 and the drawing field input manager 120 may be a single management system, program, control, or other operating feature that can command element names 20 or reference numerals 30 (and fields containing a combination of the two) to be inserted into both document files 70 and drawing files 80. The input managers 110, 120 may be part of a word processing program, drawing program, or any other that interacts with a program hosting a document file 70 or drawing file 80. The document field input manager 110 and the drawing field input manager 120 may operate as windows, toolbars, or pull-down menus from within the programs hosting the document file 70 or drawing file 80. Alternatively, the input managers may be separate program that merely interface with the operating programs.

The document field input manager 110 and the drawing field input manager 120 display a list of element names 20 and reference numerals 30 to the users, whether as fields 60 or as individual element names 20 and reference numerals 30. Thus, the user is able view the element names 20 and the reference numerals 30 while drafting a document file 70 or creating drawings file 80. The display of the input managers 110, 120 (i.e. window, toolbar, etc.) may also function as the table referenced above that allows the element names 20 and reference numerals 30 to be inputted and revised. Thus, the user is provided with an active, updateable, and modifiable list of element names 20 and reference numerals 30 that may be viewed during the drafting process. Thus, the user is neither required to repeatedly lookup nor to remember the multiple element names 20 and reference numerals 30.

Primarily, however, the document field input manager 110 and the drawing field input manager 120 provide the functionality to insert the element names 20 and the reference numerals 30 (or the associated field 60) into a document file 70 and/or drawing file 80. (It should be noted that as used herein any reference to the ability to insert an element name 20 or a reference numeral 30 into a document file 70 may likewise be inserted in a similar manner in a drawing file 80.) When the user desires to use an element name 20 and a reference numeral 30 in the document file 70, the user may select the desired element name 20 or reference numeral 30 from the input mangers 110, 120. Several options are be available for inserting an element name 20 and reference numeral 30 into a document file 70 or drawing file 80. In one embodiment, the user may use a mouse to select an element name 20 and reference numeral 30 in a window, toolbar, or the like of the document field input manager 110 or drawing field input manager 120.

By selecting or “clicking” on the desired element name 20 or reference numeral 30, the document field input manager 110 inserts the element name 20 and the corresponding reference numeral 30 at the desired location within the document file 70. The desired location may be indicated by the position of the cursor in the document 70 when the element name 20 and reference numerals 30 are selected. Once selected, the document field input manager 110 will insert the element name 20 and reference numeral 30 (or field 60 combining the two) into the document at the location of the cursor. This process may be repeated throughout the document file 70. It should be noted that the insertion of the element names 20 or reference numerals 30 into a drawing file 80 may have different insertion techniques as will be discussed later. However, should the drawing file 80 and the associated program allow for a cursor to be placed at a location in the file while selecting an element name 20 and reference numeral 30, a similar process as described above may be employed in a drawing file 80.

In another embodiment, element names 20 and reference numerals 30 may be inserted into a document file 70 through the use of hotkeys. A hotkey allows the user to insert an element name 20, reference numeral 30, or field 60, or similar insertion format, by using selective keys or a combination of keys on the keyboard. For example, one hotkey may allow the user to input the reference numeral 30 that corresponds to the reference numeral that user desires to insert, whereupon the user strikes an activation key, such as an F-key. The F-key would indicate to the document field input manager 110 or the drawing field input manager 120 to insert the field 60 corresponding to the reference numeral 30 inputted. The activation key would tell the document field input manager 110 or the drawing field input manager 120 to find the field 60 that corresponds to the reference numeral 30 and then to insert field 60 in place of the reference numeral 30 inserted by the user. In yet another embodiment, the “Ctrl” or “Alt” keys may be used to activate the document field input manager 110 or the drawing field input manager 120 to insert the appropriate fields 50. Alternatively, depressing the space bar may cause the system to examine the recently typed term and replace the term with a field 60.

Such a rapid entry system operates as the activation key is selected. The activation key causes the management system 10 to identify the reference numeral 30 that immediately precedes the location of the cursor. After identifying the reference numeral 30 that was just entered, the document field input manager 110 correlates the reference numeral 30 inputted into the document file 70 to the same reference numeral 30 within the field set 50 or in the reference database 32. The document field input manager 110 then copies the field 60 or other combination of element names 20 and reference numerals 30 and pastes it in place of the reference numeral 30 alone.

Alternatively, all or part of an element name 20 may be inputted into a document file 70 and then an activation key may be selected which inserts the field 60 into the document file 70 in place of all or part of the element name inputted. For example, to input an element named “ANKLE BONE” the document field input manager 110 allows the user to input any unique part of the word “ANKLE BONE”, such as “ANK,” “ANKL,” “ANKLE BO,” etc, then an activation key is selected. The document field input manager 110 or the drawing field input manager 120 then finds the corresponding field 60 in the field set 50, or the databases 22, 32, and replaces the portion of the element name 20 with the corresponding reference numeral 30 into the document file 70.

The use of portions of an element name 20 may function in a similar manner as inputting the reference numeral 30. The document field input manager 110 would compare the first several letters of the element name 20 inputted by the user to the element names in the field set 50. After identifying the correct field 60, the document field input manager 110 replaces the portion of the element name 20 inputted by the user with the complete field 60.

It may be preferable that the element name 20 be unique so that the system knows which element name 20 is to be inserted into the document file 70 to increase insertion speed. However, the document field input manager 110 may also include a method for inserting a non-unique element name 20 into the document file 70. In one embodiment, the presence of a non-unique element name 20 will activate a drop down menu to allow the user to select the desired element name 20 and reference 11 numeral 30. For example, if the user types “ANK” and strikes an activation-key, the system 10 may not know whether the user desires “ANKLE” or “ANKLE BONE,” assuming both are element names 20 in the element database 22. The user could then select either “ANKLE” or “ANKLE BONE.”

Rapid entry may also be accomplished through the use of pull down menus that automatically appear when the user begins typing portions of an element name 20. The user may select the desired element name 20 or reference numeral 30 from a pull down menu or press enter when only a single element name 20 appears.

The management system 10 may also include various options for inserting element names 20 and reference numerals 30 into a document file 70 in order to control the use of capitals and plurals of the element names 20 that are inserted by the document field input manager 110 or the drawing field input manager 120 from the field set 50 into the document file 70 or the drawing file 80. The insertion of a capitalized element name 20 may occur by using two different activation hotkeys. For example, F-2 may be used for lowercase and F-3 may be used for upper case. Similarly, a singular term may be inserted by pressing a hotkey and a plural term may be accomplished by pressing SHIFT and the hotkey (or visa versa). Furthermore, the control of plurals may be accomplished by buttons in the document field input manager 110 for click-and-insert functions, where the plural function may be turned on or off.

The system may also provide for a field in which the plural of each element name 20 may be entered, such that as the user originally enters an element name 20, the user will likewise enter the plural form of the element names 20. Alternatively, the system 10 may also include an intelligent function that suggests possible plural terms for each of the element names 20 that the user may accept or edit. This automated system may simply add an “s” or “es” to the end of the term based upon grammatical rules. The management system 10 may also include a library of plural terms or an active memory that remembers user inputted plural terms.

Further, the rapid entry system may include an intelligent capitalization and plural selection function. This function would analyze the term and/or punctuation prior to the location wherein the field 60 is being entered. Based upon the analysis the system would insert a capital and/or plural term. For example, if an element name 20 to be inserted is preceded by a period and multiple spaced, the element name 20 will be inserted as a capital. Similarly, the plurality of an element name 20 may determine by the preceding article or word, such as “a,” “an,” “the,” “these,” or many other terms that would be known to one having ordinary skill in the art.

In yet another embodiment, the system 10 may access rapid entry functions that are inherent within a word processing program. For example, Microsoft® Word maintains certain functionalities that allow a user to insert pre-selected terms into a document by typing the first letter of the name, upon which the program will suggest a suggested term. The present management system 10 may use such functionalities by inserting the element names 20, reference numerals 30, or fields 60 into such a functionality to allow for rapid insertion of element names 20 and reference numerals 30.

As the element names 20 and the corresponding reference numerals 30 are inserted into the document file 70, the element names 20 and the reference numerals 30 will remain constant throughout the document file 70. The consistency is caused by the element names 20 and the reference numerals 30 being inserted in fields 60. This prevents the user from unintentionally inserting an incorrect element name 20 or incorrect reference numeral 30 into the document file 70. Thus, each time an element name 20 and reference numeral 30 are inserted into a document file 70 or a drawing file 80, they will be consistent.

Another advantage of the management system 10 is the ability to uniformly and easily change the element names 20 and the reference numerals 30 in the document file 70 and drawing file 80. For example, the sample element name 20 and reference numeral 30 “FOOT BONE 112” may have been inserted in the document file 70. After “FOOT BONE 112” has been inserted into the document file 70, the user may determine that “ANKLE BONE 112” is a better element name 20. The present system allows the occurrences of “FOOT BONE 112” that were inserted into the document file 70 or drawing file 80 to be uniformly changed to “ANKLE BONE 112” by changing the element name 20 in the list of element names 20 from an interface in the document field input manager 110 or the drawing field input manager 120. The system 10 may then automatically update the element name 20 and reference numeral 30 or may require the use of an update fields command.

Similarly, the reference numerals 30 in the document file 70 and drawing file 80 may be changed by making changes to the list of reference numerals 30 in the reference database 32 through the document field input manager 110, the drawing field input manager 120 or other similar modification means. Once the reference numerals 30 are changed in the reference database 32, the management system 10 may be updated so that the changes in the list of reference numerals 30 are made throughout the entire document file 70 or drawing file 80.

Additionally, it is often desirable for the reference numerals 30 to be in ascending order throughout a document file 70. However, it can be difficult to create a list of element names 20 and provide reference numerals 30 in an ascending order based upon their occurrence in a document file 70. Therefore, the management system 10 allows the reference numerals 30 to be automatically changed such that the reference numerals 30 are in order of first occurrence in the document file 70. The system 10 would identify each reference numeral 30 and sequentially provide a new reference numeral 30 based upon its order of occurrence in the document file 70. The management system 10 would query the document file 70 from the beginning of the document file 70, or location indicated by the user. The query would create a field sequence 90 file that stores the order of occurrence of the fields 60 in the document file 70 or management system 10. The management system 10 then reorders the associated list of reference numerals 30 (fields 60) based upon the field sequence 90. The reference numerals 30 are revised so as to be in ascending order and these changes to the reference numerals are applied globally.

Additionally, it is sometimes desired to have even increments between each reference numeral 30. Thus, based upon the field sequence 90 which identifies the order of the element names 20, each reference numeral 30 may be assigned a new value based upon an initial value that may be set by the user, and an increment between the reference numerals 30 also set by the user. The management system 10 then renumbers the reference numeral 30 based upon the interval and starting value set by the user.

The present invention also allows the reference numerals 30 to be automatically selected for certain element names 20 according to parameters defined by the user. Parameters may include increments between numbers, starting numbers, figure association for series of numbers, such as 100's, 200's, etc. The figure association allows a user to select a set of number to be associated with a figure, such that a list of element names for a given figure may be provided and that the user may better manage reference numerals 30 in the figures.

Another aspect of the management system 10 may allow for a single element name 20 to be associated with more than one reference numeral 30, thus creating a composite name 40. This may occur when a group of individual elements names 20 are described with a single name or category but it is desirable to maintain the reference numeral 30 associated with each of the individual element names 20. For example, an application may recite “A FOOT BONE 4,” “AN ANKLE BONE 6,” and “A KNEE BONE 8.” If the user desired to refer to these as a single group, the user may recite “BONES 4, 6, 8.” Therefore, the system 10 allows a single composite name 40 to be linked to multiple reference numerals 30. The linking of composite names 40 allows the reference numerals 30 that are associated with the composite names 40 to be updated as the individual element names 20 associated with the reference numerals 30 are updated. Thus, the numeral 30 may be consistently maintained throughout the document file 70.

Another feature of the management system 10 is the ability to create a text document file 70 such that the individual fields 60 within the document file 70 are replaced with simple text that may be edited as with any other text in the document file 70. This may be desirable when filing a patent electronically or submitting a file to client for review, where the use of fields 60 may be cumbersome or unavailable to the recipient because of software requirements. In a document file 70 employing field sets 50 or fields 60, the system would replace the field sets 50 or fields 60 with non-updatable, simple text element names 20 and reference numerals 30.

Additionally, the management system 10 may be capable of exporting the list of element names 20 and reference numerals 30 in a separate file so that the list may be given to a draftsman, a proof reader, an inventor, etc. This list of element names 20 and reference numerals 30 may then be uploaded to a different computer where a different user will have access to the same combination of element names 20 and reference numerals 30. Thus, a user may have a list of element names 20 and reference numerals 30 that may be printed out or exported each time the element names 20 or reference numerals 30 are changed without the need to manually update a parts list.

In yet another aspect of the present invention, the management system 10 may include a drawing field input manager 0.120. The drawing field input manager 120 may function in a manner similar to the document field input manager 110 by managing reference numerals 30 inserted into a drawing file 80. However, the drawing field input manager 120 inserts the reference numerals 30 into a drawing file 80 instead of a document file 70, where objects depicted in the drawing file 80 correspond to the element names 20 and the reference numerals 30.

The drawing field input manager 120 allows the reference numbers 30, and in some instances the element names 20, to be inserted into a drawing file 80. The reference numerals 30 may be inserted into selective locations of the drawing file 80, such as at the peripherals of the drawing, and then positioned to indicate an element visually depicted within the drawing (i.e. a drag and drop). Further, the drawing field input manager 120 may input all of the referenced numerals 30 into the drawing file 80 at one time where user may thereafter reposition the reference numerals 30 adjacent the corresponding items and features in the drawings. Such a drawing file 80 may be, but is not limited to, a Microsoft Vision file, a Corel Draw® file, a Corel Designer® file, or an SVG file, or scalable vector graphics file.

Furthermore, the element names 20 may be temporarily or permanently shown within the drawing files 80 to aid in the understanding of the drawing figures and to assist in clarifying the placement of lead lines from the reference numerals 30. Once the reference numerals are properly lined up to their corresponding object, the management system 10 may remove the element names 20 from the drawing file 80. The element names 20 may be easily removed by the management system 10 replacing the fields 60 containing both element names 20 and reference numeral 30 with fields 60 containing only reference numerals 30. In the alternative, the management system 10 may insert the element names 20 and the reference numerals 30 into the drawing file 80 as separate fields 60, where either one of the fields may be selectively removed from the drawing file 80.

It should also be noted that the functionality of selectively placing either element names 20 or references numeral 30 into the drawing file 80 may also be applied to the document file 70. In some instances it may be desirable to only insert the element X name 20 within the document file 70, such as in the claims section of a patent where reference numerals 30 are generally not employed. The interface with the management system 10, such as a window or a toolbar, may include a button that will exclude the input of either the one of the element name 20 or reference numeral 30.

Returning to the drawing file 80, once the reference numerals 30 and element names 20 are inserted into a drawing file 80, the reference numerals 30 and associated element names 20 in the drawing file 80 are linked to the reference numeral management system 10. If the reference numerals 30 or corresponding element names 20 are changed in the list of element names 20 or the list of reference numeral 30, then the management system 10 will correspondingly change the effected reference numerals 30 and element names 20 in the drawing file 80. Thus, a user can update the reference numeral 30 and element names 20 with the document file 70 and have corresponding changes also occur in the drawing file 80, providing unmatched consistency throughout a technical document.

The management system 10 may also allow for messages to be embedded in the fields 60 that are active within the document file 70 and are associated the drawing files 80. The messages may be associated with element names 20 and reference numerals 30 that are inserted into a drawing to clarify the placement location of element names 20 and reference numerals 30 within a drawing file 80. In another embodiment, the messages may also be associated with the document or drawing files rather than the messages being embedded into the files. Thus, in the example of a patent application, a patent agent can provide instructions to a draftsman. Alternatively, the system may allow a draftsman or the like to embed a message associated with a reference numeral 30 or element name 20 to be viewed by a patent draftsman. The message may indicate clarification, changes or questions that may occur. The embedded messages may be either text messages or voice messages, where the field 60 carries the messages as hidden text or links to other files and databases. The messages may be selectively viewed or activated by the user. Thus, the management system 10 also provides improved communication between a patent agent and the draftsman, or the like.

Referring now to FIG. 2, the present invention may also include a correction function program 200 for identifying errors in a patent application or other similar technical writing document that did not use the above described management system 10. The correction process begins 212 within a document having both element names and reference numerals or the like. The program 200 searches a document, such as a patent application, for potential reference numerals 216. This search is typically conducted beginning to end. The reference numerals may be numbers, symbols, number and letter combinations, etc. However, it may be preferred to provide the reference numerals in a format that may be easily identified by a search function, such as numbers only with no punctuation (i.e. no commas, decimals, dollars signs, percent symbols).

The program may simply search for individual numbers or multiple numbers next to each other and include several exclusion criteria, such as excluding numbers that have commas, decimals, dollars signs, or percent symbols or exclude numbers that are preceded by the term “FIGURE”, “FIG”, or other descriptive terms designating appropriate words to be skipped. Thus, the instances of the program selecting a numeral that is not a reference numeral will be greatly reduced. Additionally, the system may allow the user to specify a range of numerals that may be applicable, such as number 10 through 500, or only three digit numbers.

The process begins by the program 200 searching for a reference numeral or number combination in a file, such as a document. The program 200 generally starts at the beginning of a document and searched for reference numerals by order of occurrence in document file. If the program reaches the end of the document (or its original starting position) and no reference numerals are identified, then the program ends 224.

In the alternative, if a potential reference numeral is located, the program 200 examines a database or ignored terms 223, which includes a list of numerals or terms that are to be ignored. This list is discussed later in more detail. If the numeral is in the ignored term database 223, then the program 200 begins searching for the next reference numeral.

If the reference numeral is not in the ignored term database 223, the program queries the users to determine if the numeral identified is a reference numeral 228. The system may highlight a reference numeral in a document file where the user may visually inspect the potential reference numeral to determine if the numeral is in fact a reference numeral. The user then provides an input as to whether the identified numeral is or is not a reference numeral 232.

If the numeral is not a reference numeral, then the program 200 places the numeral in the ignored term database 226. Thus, the next time the program 200 encounters the numeral that was place in the ignored term database, the program will automatically search for the next potential reference numeral 216 without querying the user.

However, if the user designated that the numeral located is a reference numeral 228, the program 200 then checks to determine if the reference numeral is located in the database 240. The database 240 contains a list of element names and the associated reference numerals. This list may be user programmable through the presently described process or downloaded from other programs. The database 240 allows reference numerals that are identified by step 216, 222, 225, 228 to be compared against the information within the database 240. The database 240 may also allow abbreviations or composite references to be stored in the database 240.

The program 200 queries the database 240 to determine whether the identified reference numeral is present 236 in the database 240. If the reference numeral is not in the database 240, the user may identify an element name 244 in order to store the newly identified reference numeral into the database. The user may type in the element name that is associated with the reference numeral. Alternatively, the user may highlight the associated element name using the mouse. Alternatively, the program 200 may highlight one word immediately preceding the reference numeral where the user may select additional terms in the element name by employing an “inclusion” button that allows the user to select an additionally preceding term in front of the highlighted term. If the element name has 4 words or terms in the element name, the user can press the “inclusion” button until the all four words or terms are selected.

In yet another embodiment, the system may include a “smart” function that will identify the element names. When a system identifies a reference numeral, the system may then identify one or more of the same reference numerals in later portions of the document. The system will then examine the words preceding the reference numerals to determine if the words are the same for each of the reference numerals identified. If the terms are the same for all or some of the reference numeral, the system then checks the next preceding term. Again, if the preceding terms are the same for all or some of the reference numeral, the system 200 will repeat this step. If the terms are different, then the system will establish the element names as the preceding terms that were common to all or some of the reference numeral. This process may be further assisted by examining article, or other similar grammatical indicators, that would indicate the beginning of an element name. The user may be able to edit these term in case of errors in the automatic element name identifier.

Regardless of how the element name is identified, the selected element name and corresponding the reference numeral is added 248 to the database 240. The program then again searches for the reference numeral 216. If the reference numeral is in the database 236, the program 200 checks to determine if the use of the reference numeral and the element name are the same as in the database 252. If the use of the element name and the reference numeral is the same as in the database 240, the element name and the associated reference numeral as correct and the search begins again 216.

If the element name and the reference numeral are not the same as the information in the database 240, the systems ask for the user to determine if the element name and the reference numeral are an allowable use 256. An allowable use may include abbreviation of an element name. If the use is allowable, then the use is stored in the database 240. If the use is not acceptable, the user may correct to error 260. This may involve changing the element name, the reference numeral, or both. Then process then continues at step 216 until all of the search term have been examined and corrected.

The program 200 also functions to create a parts list in the database to compare against uses in the application. The system may allow the parts list to be used to draft a patent application according to the invention as described in FIG. 1. As discussed above, a library of element names and reference numerals may be established. The library may employ the process of FIG. 2 to collect element names for a parts list from an existing patent or similar document. The parts list collected from the process of FIG. 2 could simply be saved into the library from which it will be exported into the list of element names and reference numeral. The library may be stored in separate categorically and maintain in separate databases. The library allows a user to collect and share lists of element names 20 and reference numeral 30 to be used for any number of projects. The list within the library are also editable to allow each list of element names 20 and reference numeral 30 to be customized for each project. The library may also allow for multiple lists to be combined and edited, reducing insertion time.

The present invention may be embodied in other specific forms without departing from its structures, methods, or other essential characteristics as broadly described herein and claimed hereinafter. The described embodiments are to be considered in all respects only as illustrative, and not restrictive.

The follow sample claims are provided for disclosure and support of a future claims set are not provided to define the scope of the invention. No amendment to the sample claims are to be construed as creating prosecution history estopple.

1. A system for managing reference numerals comprising:
an element database for receiving and storing a plurality of element names;
a reference database for receiving and storing a plurality reference numerals, wherein selective reference numerals in the reference database correspond to selective element names in the element database; and
a manager system in communication with the element database, the reference database, and at least one document file, the manager system providing for user designated insertion of element names and reference numerals into the document file, wherein changes to an element name in the element database or changes to a reference numeral in the reference database, correspondingly change the element name or reference numeral in the document file.

2. The system, as recited in claim 1, wherein the manager system is one of a window, pull down menu, and toolbar accessible at least through a word processing program.

3. The system, as recited in claim 1, further comprising a numbering system for automatically creating reference numerals within the reference database, wherein the reference numerals are created based, at least, upon user selected parameters of starting value and interval value.

4. The system, as recited in claim 1, wherein the reference numerals are re-defineable in the numeral database based upon the sequential placement of the reference numeral in the document file.

5. The system, as recited in claim 4, wherein the reference numerals are re-defineable in the numeral database such that the reference numerals are in assenting order within the document file.

6. The system, as recited in claim 1, wherein the manager system is operatively related to at least one hotkey operable within a document file operating program, wherein an element name and a corresponding reference numeral may be inserted into the document file upon operation of the hotkey.

7. The system, as recited in claim 6, wherein operation of the hotkey in association with inputting a selective reference numeral inserts the element name that corresponds to the selective reference numeral.

8. The system, as recited in claim 6, wherein operation of the hotkey in association with inputting portions the selective element name inserts the selective element name and the corresponding reference numeral.

9. The system, as recited in claim 6, wherein the hotkey allows for selective insertion of a singular or plural of an element name.

10. The system, as recited in claim 6, wherein the hotkey allows for selective insertion of a capitalized or lowercase form of an element name.

11. The system, as recited in claim 1, wherein the element name and the reference numeral are maintained within a field within the document file.

12. The system, as recited in claim 1, wherein the system manager allows element names to be inserted into document file wherein the corresponding reference numeral are omitted.

13. The system, as recited in claim 1, where in the element database includes a list of plurals for the corresponding element names.

14. The system, as recited in claim 1, wherein the element names and reference numerals are insertable into a drawing file, wherein changes to an element name in the element database or changes to a reference numeral in the reference database, correspondingly change the element name or reference numeral in the drawing file.

15. The system, as recited in claim 14, wherein the element names are selectively removable from the drawing file by the manager system.

16. The system, as recited in claim 14, further comprising a system for associating messages with the reference numerals and element names within the drawing file for providing instructions relating to placement of the reference numerals and element names within the drawing file.

17. The system, as recited in claim 1, wherein the element database and the reference database are part of a library of element databases and reference databases.

18. The system, as recited in claim 1, further comprising a means for inserting at least one of the element names and reference numerals into the document file.

19. A method in a computer system for managing reference numerals, the method comprising:
inserting fields into a text file, wherein the fields are made of element names from an element database and reference numerals from a reference database, wherein selective element names are associated with selective reference numerals;
inserting the fields into a drawing file;
revising at least one of the element names and reference numerals within the element database and reference database respectfully, such that changes to the element names in the element database and changes to the reference numerals in the reference database change the fields inserted in the text file and the drawing file.

20. The method, as recited in claim 19, wherein the at least one of the element names and reference numerals is revisable thought one of a window, pull down menu, and toolbar accessible within a program by which the text file is created.

21. A method in a computer system for identifying errors in a document having element names and associated reference numerals, the method comprising:
a) identifying a reference numeral within a text document;
b) providing for selection of an element name associated with the reference numeral form the text document;
c) storing the element name and the associated reference numeral in an element name and reference numeral database, such that the reference numeral and element name are associated;
d) identifying subsequent occurrences of the reference numeral, wherein the subsequent occurrence of the reference numeral and the associated element name are compared with the element name and reference numeral database;
e) indicating the presence of an inconsistency between the reference numeral and element name in the database and the subsequent occurrence of the reference numeral and the element names in the text document; and
f) repeating steps a) through e) for other reference numerals and element names until an determined number of reference numerals are identified.

22. The system, as recited in claim 21, further comprising a means for selecting an element name to associate with an identified reference numeral.
